(19) United States
(12) Patent Application Publication
(10) Pub. No.: US 2014/0024425 A1
(43) Pub. Date: Jan. 23, 2014

(54) POKERLETTE

(71) Applicant: HMD Entertainment, LLC, Rochester, NY (US)

(72) Inventors: Ronald J. Wolff, Rochester, NY (US); Michael A. Wolff, Conshohocken, PA (US); Steven J. Wolff, Las Vegas, NV (US)

(73) Assignee: HMD Entertainment, LLC, Rochester, NY (US)

(21) Appl. No.: 13/944,063

(22) Filed: Jul. 17, 2013

Related U.S. Application Data
(60) Provisional application No. 61/672,817, filed on Jul. 18, 2012.
(60) Provisional application No. 61/722,896, filed on Nov. 6, 2012.

(51) Int. Cl. G07F 17/32

(52) U.S. Cl. CPC G07F 17/3244
USPC 463/11; 273/292

(57) ABSTRACT

Disclosed herein are a casino game as well as the methods and apparatus for conducting the game. In one embodiment, the Pokerlette™ game includes a game table or surface (physical or virtual) on which wagering and steps of the game are carried out using playing cards to implement the game as a combination of poker and roulette.

Priority is claimed from U.S. Provisional Patent Application No. 61/672,817 for “POKERLETTE,” filed Jul. 18, 2012 by R. Wolff, and from U.S. Provisional Patent Application No. 61/722,896 for “POKERLETTE,” filed Nov. 6, 2012 by R. Wolff, both of which are hereby incorporated by reference in their entirety, including any appendices.

Disclosed herein are a casino game as well as the methods and apparatus for conducting the game. In one embodiment, the Pokerlette™ game includes a game table or surface (physical or virtual) on which wagering and steps of the game are carried out using playing cards to implement the game as a combination of poker and roulette.

### BACKGROUND AND SUMMARY

The following disclosure is directed to a totally new type of casino game entitled Pokerlette™ which incorporates many aspects of the most popular casino table games. The disclosed game, including various embodiments and alternatives, provides an enjoyable experience for the three or five card poker player, the roulette player and the keno player. The disclosed game also has a “slot machine” betting component with a “progressive” payout. The game is designed to be fair to both the player and the casino house, although it easily allows for variations of betting types and odds as the house wishes. It is simplistic in design which allows the casual observer to easily understand the flow of the game and join in the fun.

The game provides for two simultaneous poker games to be carried out while wagering is enabled using a roulette-type table or board on a table-top or similar horizontal playing surface, and neither game requires the player to best the dealer or another player to win. Unlike other roulette type card games, “inner board” bets in this game are active throughout the entire round or hand and the player has five chances to win these wagers. This game also has a unique three-card poker hand bet, which determines winners based on the first three cards revealed. Another unique feature is the possibility of player input to enhance the randomness of the game. The game has a separate wagering element called “Lucky 7's™” which is a side bet. The game incorporates both Jokers as totally separate cards. The game has two areas on the “inner board” layout where three cards (a Joker with two Aces) intersect to form a unique “three point” junction for wagering.

Disclosed in embodiments herein is a method of playing a game, comprising: (a) providing a deck of playing cards that includes two Joker cards; (b) providing a wagering area in which wagers may be placed by participants in a roulette-type fashion, wherein the area includes (1) an inner board comprising, a plurality of spaces representing single card wagers and multiple card wagers that any revealed cards will be the single card or one of a group of multiple cards; (2) an outer board comprising a plurality of spaces to represent a wager for at least one of a predetermined group of wagers; (c) providing a card presentation region, separate from the wagering area; and (d) the game being played by the following steps, (1) at least one player commences wagering by placing a marker of said wager in the wagering area, (2) dispensing at least one packet of five cards, (3) placing each packet on its own layout space, (4) making a packet selection, if more than one packet is dispensed, for use in the game, and discarding all non-selected packets to leave a selected packet, (5) laying out all five cards of the selected packet face-down in order on the layout spaces, and announcing the end of wagering, (6) successively revealing the first through fifth cards and after revealing each card removing non-winning bets from the wagering area, (7) paying, as winning bets, all those wagers for which markers remain in the wagering area, and (8) the hand ends.

Further disclosed herein is a method of playing a casino game, comprising:

(a) providing a “deck” (physical or virtual) of 54 playing cards that includes two Joker cards;

(b) providing an area in which wagers may be placed by participants in a roulette-type fashion, wherein the area includes (1) an Inner Board comprising, a rectangular layout including 52 playing card spaces such as rectangles in a 13×4 rectangular arrangement representing the 52 face cards, said rectangles being arranged in columns by suit and in rows by card, from Ace to King, and two Joker rectangles each representing one of the two Jokers, where the playing card and Joker rectangles allow for wagering on single cards or groups of two, three or four cards that any of five revealed cards will be the single card or part of a group; (2) a plurality of rectangular areas for wagering on one or two suits of the designated card (e.g., first card revealed) regardless of face; (3) a plurality of areas to allow for wagering on one or two sets of faces of the designated card regardless of suit; (4) a plurality of areas for wagering that the designated card will be a face card from Ace to Six or either Joker; (5) an area for wagering that the designated card will be red in color (Heart or Diamond); (6) an area for wagering that the designated card will be a face card from Eight to King or either Joker; (7) an area for wagering that the designated card will be black in color (Spade or Club); (8) an area for wagering that the first three cards revealed will form a winning three-card poker hand; (9) an area for wagering that all five cards revealed will form a winning five card poker hand; and (10) an area for wagering that a minimum of two Seven face cards or Jokers, or any combination thereof, will appear among the five cards revealed;

(c) providing a card presentation region, said presentation region including a plurality of layout spaces located away from the wagering area; and

(d) the game being played by the following steps, (1) the players commence wagering; (2) a shuffling device (e.g., SHFL Entertainment, www.shufflemaster.com) or dealer manually dispenses seven packets of five cards each, with the remaining cards being placed in a discard rack; (3) the dealer places the packets on seven layout spaces located away from the wagering area; (4) a selected player announces his or her choice for packet selection from 1 to 7, and the dealer places a dealer marker on the selected packet for use in the game as the game packet, and puts all remaining packets in the discard rack; (5) the dealer lays out the five cards face down in order on the spaces marked 1^{st} through 5^{th} and announces the end of wagering; (6) the dealer reveals a top card of the game packet and places it in a designated ‘one” space for card layout; (8) all first card wagers are settled and any “Inner Board” winners are paid; (9) the dealer reveals a second card of the game packet and places the second card in a designated “two” space for card layout; (10) any “Inner Board” winners are paid; (11) the dealer reveals a third card of the game packet and places it in the designated “three” space for card layout; (12) all three-card poker hand wagers are settled and any “Inner Board” winners are paid; (13) the dealer reveals a fourth card of the game packet and places it in the designated “four” space for card layout; (14) any “Inner Board” winners are paid; (15) the dealer reveals a fifth and final card of the game packet and places it in the designated “five” space for card layout; (16) all “five card poker”, “Lucky 7's™”, and any “Inner Board” winners are paid as well as losers removed; and (17) the hand ends.

Further disclosed in embodiments herein is the casino game as disclosed, wherein the wagering area and card presentation area are displayed on a video display, and where wagers are placed by players via a user interface such that the wagers are depicted on said display.

Also disclosed herein is a casino game “board” comprising a wagering area in which wagers may be placed by a participant(s) in a roulette-type fashion, where the wagering area includes:

(1) an inner board comprising, a rectangular layout including 52 playing card spaces in a 13×4 rectangular arrangement representing the 52 face cards, the spaces being arranged in columns by suit and in rows by card, from Ace to King, and at least two Joker rectangles each representing one of the two Jokers, where the playing card and Joker rectangles allow for wagering on single cards or groups of two, three or four cards that any of five revealed cards will be the single card or part of a group;

(2) a plurality of rectangular areas for wagering on one or two suits of the designated card revealed regardless of face;

(3) a plurality of areas to allow for wagering on one or two sets of faces of the designated card regardless of suit;

(4) a plurality of areas for wagering that the designated card will be a face card from Ace to Six or either Joker;

(5) an area for wagering that the designated card will be red in color (Heart or Diamond);

(6) an area for wagering that the designated card will be a face card from Eight to King or either Joker;

(7) an area for wagering that the designated card will be black in color (Spade or Club);

(8) an area for wagering that the first three cards revealed will form a winning three-card poker hand;

(9) an area for wagering that all five cards revealed will form a winning five card poker hand; and

(10) an area for wagering that a minimum of two Sevens or Jokers, or any combination thereof, will appear among the five cards revealed.

The disclosed game has odds for each type of wager that have been researched and tested with trials using computer methodology. These odds, and possible payouts, will be discussed in the detailed description of the game. This is not to suggest that the game is dependent on the stated odds and that changing the odds and payouts will fundamentally alter the game or create a new type of game. It is quite possible that a casino or state gaming commission may wish to alter the odds and/or payouts for the benefit of either the players or the casino establishment.

### BRIEF DESCRIPTION OF THE DRAWINGS

FIG. 1 is an illustration of the game board layout in accordance with one embodiment of the Pokerlette game;

FIGS. 2, 5, 6 and 7 are representations of the game board layout for illustration of betting types or situations;

FIGS. 3 and 4 depict a flow chart describing the order and mechanics of the game play per hand;

FIGS. 8-11 are illustrations of alternative virtual embodiments for video and on-line implementations of the disclosed game;

FIG. 12 is a spreadsheet illustrating an exemplary simulation of one embodiment of the Pokerlette game and associate results;

FIG. 13 is a spreadsheet illustrating two examples of profitability based upon exemplary wagers and hands/hour;

FIG. 14 is a flowchart of the describing the game operation, including details from the dealer's perspective; and

FIG. 15 is another embodiment of a game layout suitable for use on a typical casino table

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

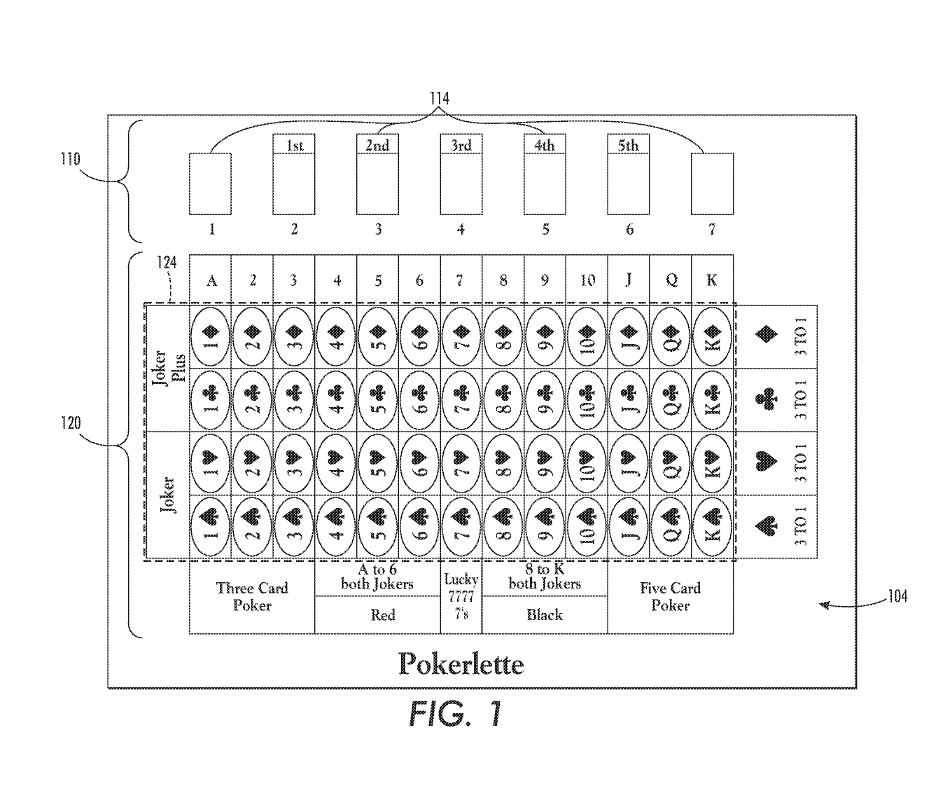

Referring initially to FIG. 1, depicted therein is an exemplary game board layout for Pokerlette. Although described relative to FIG. 1 as an example, it should be appreciated that various layouts and modifications may be employed to facilitate the playing of the game in either a physical or virtual (i.e. computer-based) manner, and that all such layouts and modifications are intended to be included within the scope of this description. For purposes of illustration, certain face cards are represented in game boards and the like, or in the figures and description herein, using capital letters “A” for Ace, “J” for Jack, “Q” for Queen and “K” for King. The suits may be represented in small or large letters by “s” for Spades, “h” for Hearts. “c” for Clubs and “d” for Diamonds, providing an area in which wagers may be placed by participants in a roulette-type fashion, which may be done on a physical table or board, or on a virtual (video) interface.

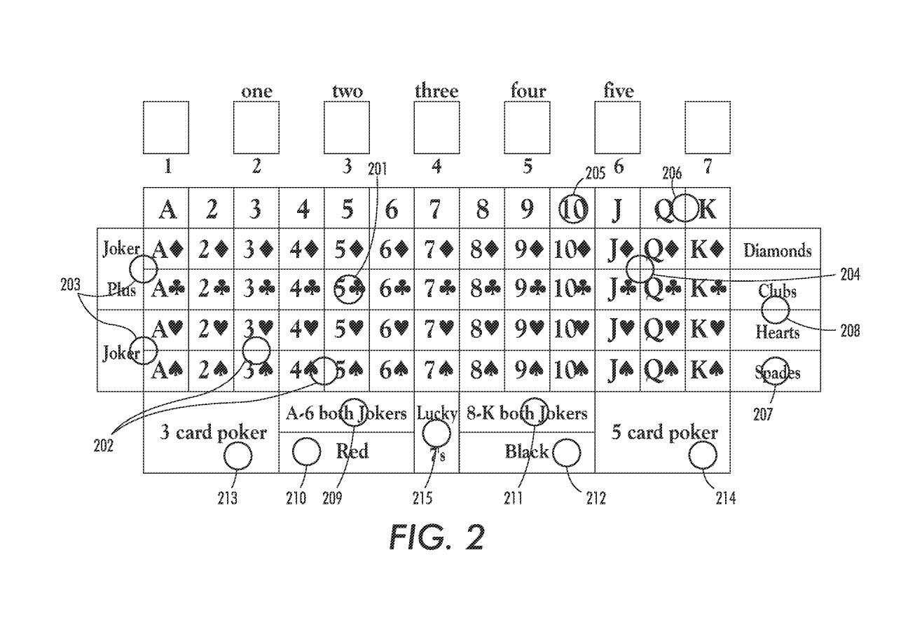

A wagering area includes (1) an inner board, and (2) an outer board. The inner board wagering area comprises: a rectangular layout including 52 playing card squares, rectangles or similar spaces in a 13×4 arrangement representing the 52 face cards, said squares being arranged in columns by suit and in rows by card, from Ace to King, and two Joker rectangles each representing one of the two Jokers, where the playing card and Joker rectangles allow for wagering, on single cards or groups of two, three or four cards, that any of five revealed cards will be the single card or part of a group. Any of the 54 cards in the inner board may be wagered on individually by placing a chip on its corresponding board space which will be referenced by the term “single card” wager (e.g., the five of Clubs, FIG. 2, 201). Any adjoining two cards in any direction, including the Jokers, may be bet by placing a chip on their connecting line (i.e., the line dividing the spaces for each card). The player is wagering that either of the two cards will be revealed, which will be referenced by the term “two card” wager (see example for the Three of Hearts with the Three of Spades in an across suits wager and Four of Spades with Five of Spades in a down face cards within the same suit wager (see examples in FIG. 2, 202). There are two locations, each of which will be referenced by the term “three card” wager, where borders of Jokers and Aces intersect (see example for the Ace of Hearts, Ace of Spades, and Joker, FIG. 2, 203). Unlike other roulette type card games, the game has two locations on the “inner board” where the three cards can be wagered on as a group. At other border intersection points, players may bet on four cards simultaneously by placing chips which will be referenced by the term “four card” wager (see example for the Jack of Diamonds, Queen of Diamonds, Jack of Clubs, Queen of Clubs, FIG. 2, 204. Players may also bet a row on the inner board, which is the equivalent of a “four card” wager. For this type of bet, only one row is allowed; in other words, a player is not allowed to split two inner board rows to cover eight cards. The table surface itself may further include graphics and text information characterizing instructions, odds, etc. to assist the player.

The outer board region, outside of the inner board, permits wagering on other card combinations, including: row (card value), column (card suit), card ranges (e.g., Ace to Six, Eight to King), poker hands (e.g., three card poker hand, five card poker hand), Lucky 7's™, etc.

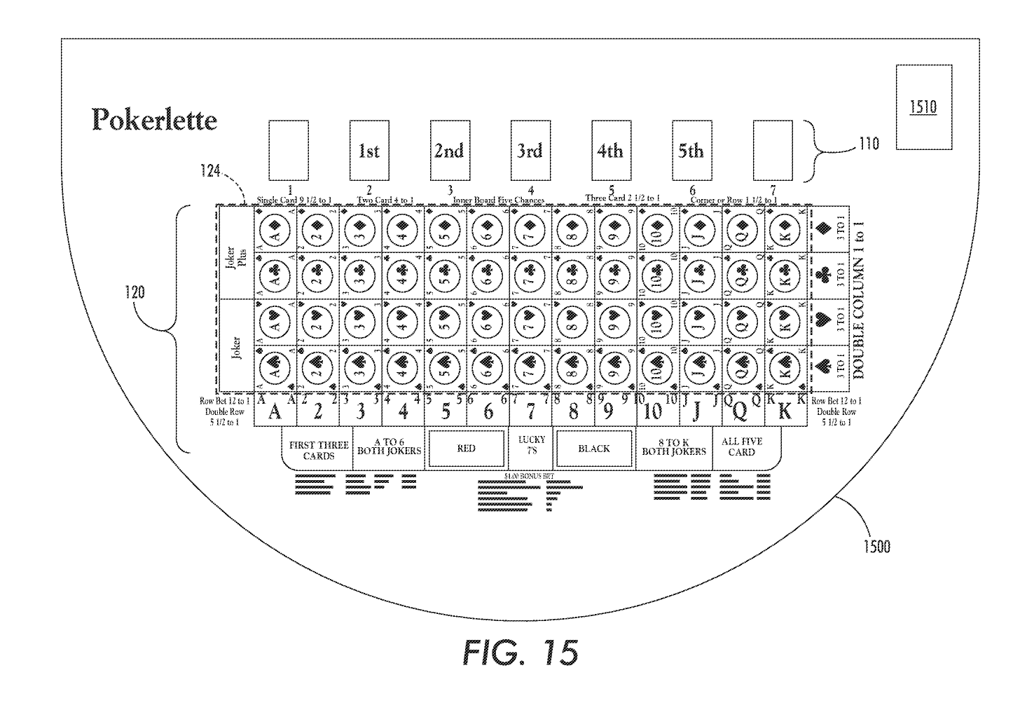

Continuing to refer to FIGS. 2 and 15, the wagering area also includes a plurality of rectangular areas for wagering on one or two suits of the designated card (e.g., first card revealed), regardless of face, which will be referenced by the terms “column” wager for one suit (see FIG. 2, 207) and “double column” wagers for two adjacent suits (see FIG. 2, 208). A plurality of areas to allow for wagering on one or two sets of faces of the designated card, regardless of suit, which will be referenced by the terms “row” wager for one face card are also illustrated in FIG. 2, see 205). Similarly, a “double row” wager for adjacent face cards is illustrated in FIG. 2 at 206. An area for wagering that the designated card will be a face card from Ace to Six or either Joker, which will be referenced by the term “Ace to Six both Jokers” wager, can be seen at 209. An area 210 is provided for wagering that the designated card will be red in color (Heart or Diamond), and, an area for wagering that the designated card will be black in color (Spade or Club) is indicated as 212. An area for wagering that the designated card will be a face card from Eight to King or either Joker, which will be referenced by the term “Eight to King both Jokers,” is indicated at 211 and an area for wagering that the first three cards revealed will form a winning three-card poker hand is represented in region 213. The wagering area also includes a region for wagering that all five cards revealed will form a winning five card poker hand at 214, as well as a region for wagering that a minimum of two of the combination of Sevens or Jokers, including combinations thereof, will appear among the five cards revealed, which will be referenced by the term “Lucky 7's™” side wager, as indicated at 215. Referring also to FIG. 1, the playing board or display further includes providing a card presentation region 110, where the presentation region includes a plurality of layout spaces 114 located away from the wagering area.

Although described herein in the embodiment of a casino game played within a casino on a game table, it will be appreciated that various aspects of the disclosed game may be similarly presented in an electronic game format. For example, the game may be played on a video gaming system, stand-alone or on-line, where one or more users may place wagers and perform the actions of a player (i.e., virtual player) and where the computer (local or a server-based system) performs the operations of the dealer or the “house” relative to analyzing wagers and payout out winnings. In a video gaming environment, playing of the game is contemplated wherein users may be represented by personalized avatars or similar iconic characterizations. Thus, the game may be played in a computer-simulated version or as a multi-player game where other users are similarly “on-line” and playing around the same game surface. It should be further understood that an on-line version of the disclosed game may be displayed as a simple table-top displaying wagers and cards as dealt (e.g., a top-down view of a representative playing surface), or the game may be animated and/or three-dimensional so that the actions of the players and dealers are realistically simulated (e.g., placing of wagers, dealing and revealing cards, etc.) to provide an experience as though a user were playing at a casino.

Similarly, although characterized using conventional casino components such as chips of different value, it will be appreciated that aspects of the disclosed Pokerlette game may be carried out using a digital or similar gaming table whereby at least the table surface is implemented using a large format display device, and wagers are placed by users using some form of interactive interface. As an example, similar to games provided by companies such as BingoTimes™ (http://www.bingotimes.com.tw/english/index.html), a user may have a digital representation of chips on a “stack” in front of them, and even a game board, and the user could select and drag a chip icon(s) from the player's stack to one of the wagering locations identified herein, in the same manner that an icon can be dragged and dropped on a conventional user interface, in order to place a wager. Likewise, in the event of a wager that pays off, the user's stack would be credited and receive additional chips upon payout.

Although it will be appreciated that wagers may be represented in monetary units where appropriate or legal, non-monetary units may be employed in such games as well. Although the present invention is described herein in considerable detail with reference to certain versions thereof, other versions are possible. As noted above, for example, the gaming method described is not limited to being played as a table game. The game may be played as a board game or by using computers or electronic devices having audio and video outputs. Thus, the term “card” as used in this application refers to traditional playing cards made of paper stock having game indicia, such as numbers (2-10), suits (Diamonds, Hearts, Spades, and Clubs), and characters (Aces, Jacks, Queens, and Kings). The term “card” is also used to refer to one of a plurality of electronic images of traditional cards. The term “dealer” may be an actual person distributing the cards. It is noted that the dealer may also be a player, and the dealer does not have to be associated with a business entity having a stake in any profits derived from operating the game. The term “dealer” may also be used to refer to a virtual dealer that is programmed through an electronic device or computer. And, the function of the dealer may also be performed, or at least assisted, by any of a number of gaming-based devices including automated card shuffling devices as well as robotic arms suitable for shuffling, dealing, revealing cards, removing wagers, etc. One example of such a device is available from Bingo Times Digital Technology Co. Ltd of Taiwan (e.g., Model R200 offers a complete Roulette set up with an automated arm for Croupee).

The game disclosed herein can be readily implemented in a wide variety of additional forms and media including, but not limited to: single player slot video machines, multi-player slot video machines, electronic games and devices, lottery terminals, software, as well as home, and Internet entertainment. Furthermore, the game can be readily implemented in software, which can be downloaded or stored on a disk (e.g., magnetic disk, compact disc (CD), USB memory stick, etc.,) and used with a computer system. In one embodiment, the gaming method of the present invention may be implemented as a computer game which may be executed via disk or downloaded from the Internet and played using a computer, gaming console, or an electronic handheld device (e.g., personal digital assistants (PDA), smart phones, etc.). Such embodiments may be played individually or may be played with other players. In another embodiment, the disclosed game may be played as an interactive online gambling game wherein the player may play against the dealer individually or with other players via the Internet. The dealer may be an actual person or a virtual dealer. Similarly, the other players may be actual people or they may be computer generated virtual players. In yet other embodiments of the invention, the gaming method may be played against a casino or wagering establishment from a remote location via the Internet.

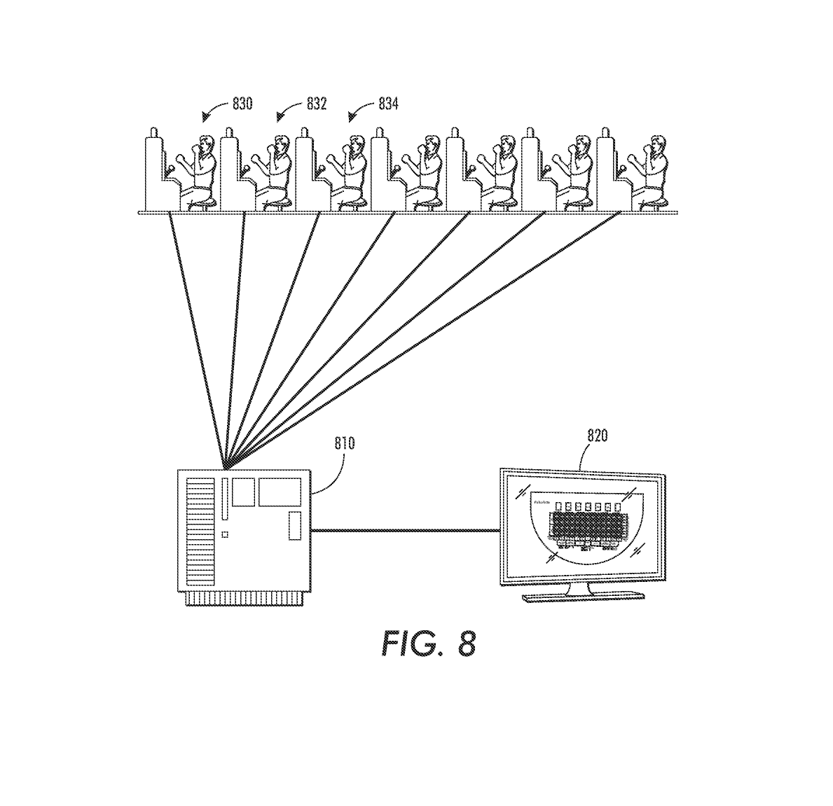

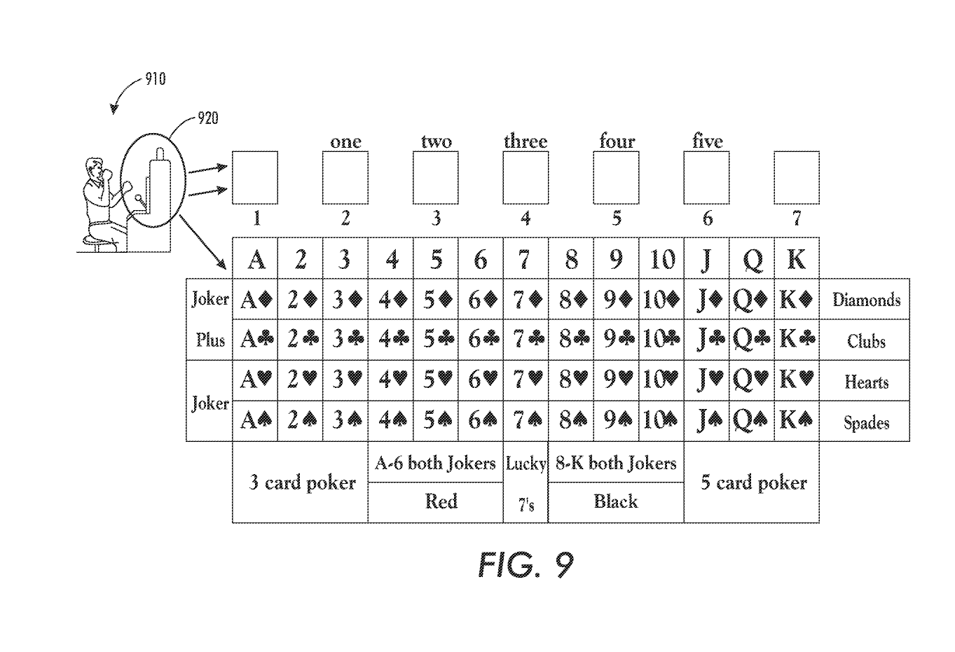

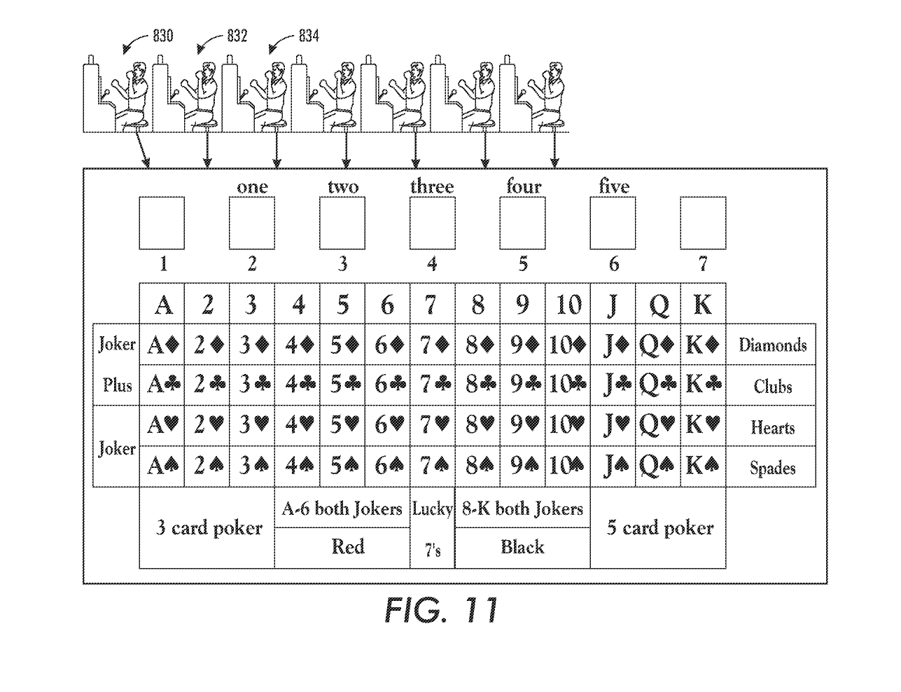

Certain gamblers feel uncomfortable with the fast pace and frenetic activity which often accompanies multiple players around a table game such as roulette. There are electronic formats found in the casino environment that provide differing levels of privacy for the player. FIG. 11, for example, depicts multiple players 830, 832 and 834 (seven are displayed although the number could vary) using an electronic video touch screen format to place wagers for what otherwise would be a regular table format with a dealer revealing cards, marking spaces on the game board, and inputting the revealed cards to a console. A Computer Central Processing Unit (CPU) or individual processors in each player's video terminal would settle wagers and tally present account totals. FIG. 8 depicts a similar scenario of multiple players (830, 832, 834) with individual touch screen terminals having their wagers centrally processed for computer graphic display on a large wall monitor 820. FIG. 9 depicts a user or player 910 having a private game on his/her touch screen terminal 920 without multiplayer interaction. All of the above-mentioned scenarios have been experienced for roulette play at various casinos. Accordingly, it is not to be construed that only certain input device types, processing device types, or display device types could be used with the disclosed embodiments. Rather, the present disclosure contemplates the use of currently available as well as future electronic, mechanical and/or electromechanical devices and systems that may be employed to carry out one or more features and operations of the game as disclosed herein.

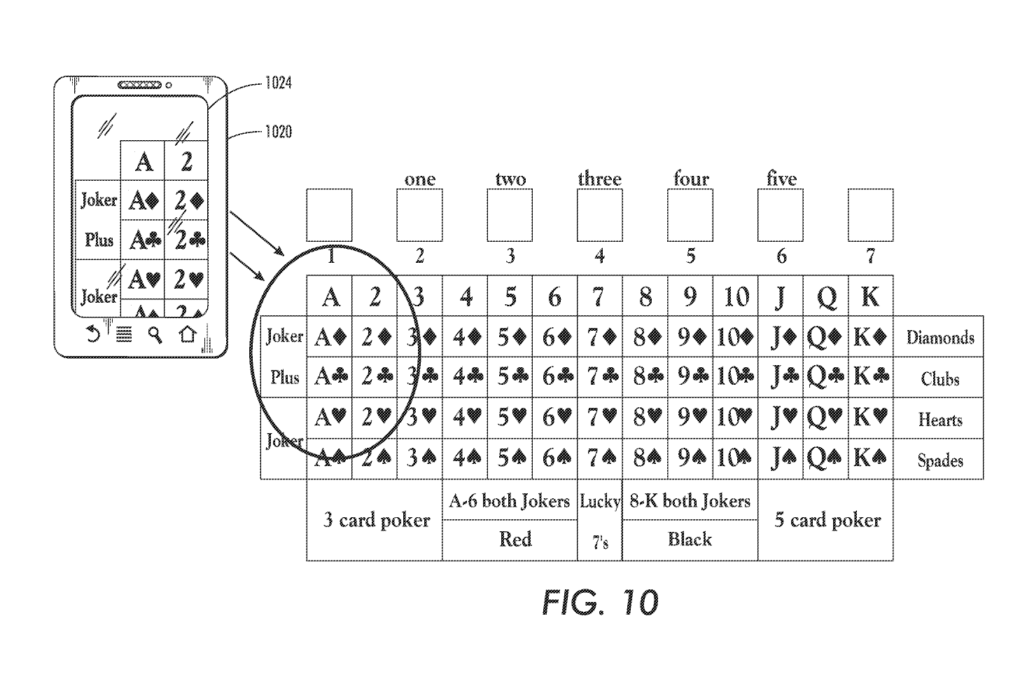

FIG. 8 is also intended to depict the scenario of players using individual computing devices for Internet or other networked game play. Instead of wagering being displayed on a central screen, it would be fed back to each individual computer through the main website server. It is also quite possible the game could be played by individuals with downloaded software which would not involve internet interaction. FIG. 9 is an illustration of just such a scenario, where the user is essentially playing on and against only the computer (or possibly other simulated players), and the computer carries out the functions of the dealer or house. FIG. 10 is intended to represent a portable cellular or smart phone device 1020 being used with a downloaded application to play the game. Since the game board size may create visual issues on small screens, a “zoom in” ability is depicted in region 1024, where the board could be scrolled (e.g., using known gestures, navigational buttons or techniques) for betting or game play purposes. Only parts of the board would likely be on display at one time with this type of device, but this is not to construe that the game would be fundamentally changed with any board depiction which deviates from the described board, even though there may be modifications in order to permit a more user-friendly video display. Nor should it be construed that the screen size of the portable device is a factor requiring fundamental change. Nonetheless, the layout or format of the game board may be modified in order to permit ease of use or wagering via hand-held or other portable devices.

The game can also be played in home table form for private party purposes. It can be marketed and used as any other board game with or without electronic components. For example, an electronic card shuffler, packet dealer, and card revealer could be envisioned for an otherwise manual board game. A designated dealer can manually do these tasks as well, which is the manner in which the board depicted in FIG. 1 or 15 is used.

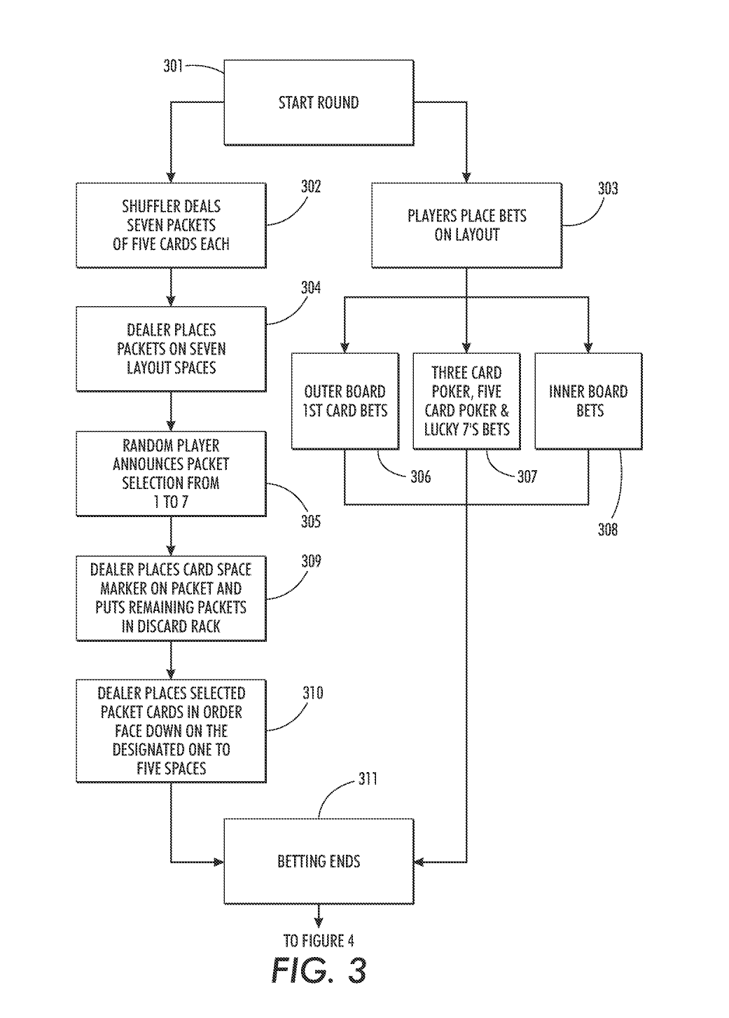

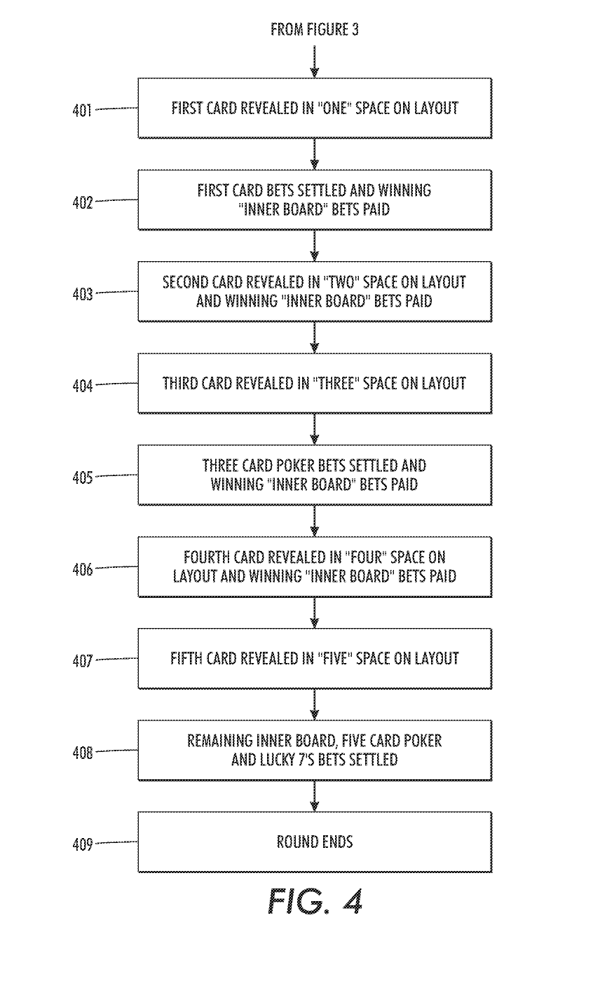

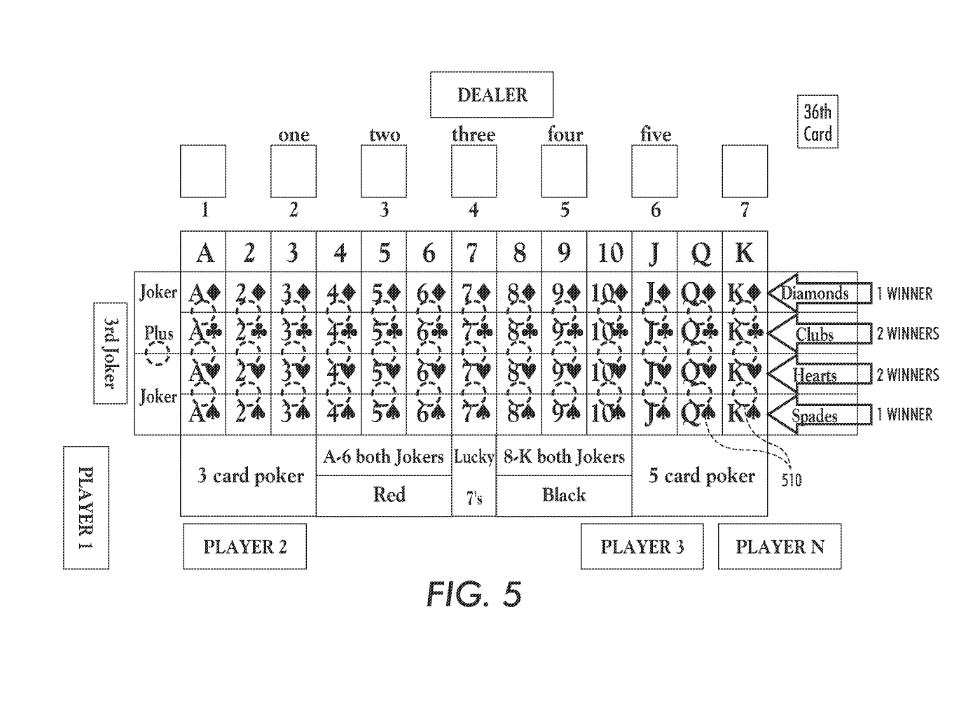

Having described the general layout of the playing board or surface, as well as several virtual game embodiments, and with the various bets that can be played thereon, attention is next turned to the manner of playing an exemplary game. Referring also to FIGS. 3 and 4, one embodiment of the game may be played by the following steps. Additionally, some steps of the game described herein may be added, omitted or modified. First, the players (e.g. player 1 to N, as illustrated in FIG. 5) commence wagering on any or multiple regions of the game board as previously discussed. The suggested odds for such betting will be elucidated later in relation to wagers 303, 306, 307, 308, for example. Next a card shuffling and dealing device or dealer, generally positioned as illustrated in FIG. 15 (1510), dispenses seven packets, each having five cards each, with the remaining cards being placed in a discard rack, see FIG. 3, 302. As represented by 304, the dealer then places the packets on seven layout spaces 114 located away from the wagering area, and randomly selects a player to make a packet selection. The selected player announces his or her choice for packet selection from one of the seven packets on the table (305), and the dealer places a dealer marker on the selected packet for use in the game as the game packet, and puts all remaining packets in the discard rack (309). Although described relative to a seven-packet layout, it will be appreciated that the game may be altered to use any number of packets. For example, in one embodiment, only a single packet of cards is dealt and there would be no selection of packets by a player or other means.

In an alternative embodiment, selection of the packet for card revelation could be done without player selection, for example, selection could be randomly determined by mechanical, electromechanical, or electronic device such as a roulette-type wheel, a computer-based random selection device, or even a seven-facet die (e.g., pentagonal prism and variants thereof). Next, the dealer lays out the five cards from the packet face-down, in order on the spaces marked 1st through 5th represented by 310, and announces the end of wagering (311). The dealer then reveals the “‘one” space card again represented by FIG. 4, 401. Once the first card is revealed by the dealer, all first card wagers are settled and any “inner board” winners are paid as represented by step 402. Next, the dealer reveals the second card on the designated “two” space of the card layout. Any “inner board” winners are then paid as represented by step 403. The dealer continues at 404 and reveals the third card from the designated “three” space of the card layout. Once again, the wagers are reviewed and all three-card poker hand wagers are settled and any “inner board” winners are paid as represented by 405. The dealer then reveals the fourth card from the designated “four” space of the card layout, and any “inner board” winners are paid (406). Finally, the dealer reveals the fifth card from the designated “five” space of the card layout (407) and all “five card poker”, “Lucky 7's™”, and any “inner board” winners and losers are settled as represented by step 408 before the hand ends at 409.

As has been described above, the game includes the ability to play and wager on two simultaneous poker games (three and five card hands) within one hand of card revelation, a characteristic that is not believed to be found in other games. Moreover, the game does not require a “draw” of extra cards, nor does it require a revelation of extra cards to attempt to improve the existing poker hands. Unlike known poker games that are not purely video or electronic in nature, there does not have to be any competition between the player and the dealer or other players. In other words, wagering is based upon the five-card packet, not subsequent wagering or card draws, although it may be that the game could be modified to incorporate such changes. As the basic game is described herein, it does not allow for wagering after revelation of any cards.

As briefly described, one of the game's two simultaneous poker games is a version of a three-card poker hand, which determines winners based upon the first three cards revealed. This attribute is not found in Roulette or other games that include Roulette-type wagering but employ cards or additional means to replace the roulette wheel. In the disclosed embodiments, the game may uniquely require player input to enhance its randomness. For example, seven “five card packets” are dealt and placed in their respective rectangles on the game board layout (see FIG. 1, region 110). A player is selected by the dealer to decide and announce which packet will be chosen to be the active five cards to be individually revealed in that hand. This feature is similar to the craps player whose turn it is to be the “shooter” or dice thrower. The game uses this technique to provide, in effect, a final “cutting” of the top 35 cards in the 54 card deck, which increases the randomness previously referred to.

As noted above, the game also has a separate side wager entitled “Lucky 7's™” which provides the opportunity for large payouts up to and including a “progressive” payout which can reach into the hundreds of thousands of dollars. The player making this bet is wagering that a minimum of three of a combination of Sevens and Jokers will appear among the five revealed cards during the hand. The more Sevens that appear, the larger the payout, up to four natural Sevens and one of the two Jokers, the latter combination paying out the “progressive” pot. This feature of the game is a “slot machine” component with each card revealed representing a “reel” of the “machine”. In an alternative embodiment, the Lucky 7's wager may pay out for as few as two Sevens and/or Jokers, and the payout may be a fixed amount at each level from two to five cards. For example, the jackpot for a hand of four Sevens plus a Joker could be a fixed amount (e.g., $100K) or a progressive payout.

The disclosed game further incorporates two separate Joker entities or cards, the plain Joker and the “Joker Plus™” which is the Joker with the card manufacturer's guarantee. The two Jokers may be wagered on individually, as a “two card” bet together across their border, or in conjunction with Aces that they border. This is not to construe that the Jokers cannot be distinguished by other methods. Some playing card manufacturers may use different colors for Jokers or other differentiating qualities. The game could also be played with a single Joker or two identical Jokers, which would alter the odds without necessarily altering the format of the game or its method of play.

There are certain nuances found at the roulette tables in the casino environment and these are easily addressed in the disclosed game. When a number comes up in roulette and the dealer marker is placed on the board, it is placed on top of the winning chips. This is considered “good luck” for the player who often keeps the chip on the table to duplicate the bet for the next hand. This is also done in the disclosed game. When a player has a winning “two card”, “three card”, or “four card” bet, the player is given the option of letting the winning initial chip “ride” and stay in the game for that hand, or taking it with the winnings. If the player elects to let the chip stay, the player must have another winner with it, or it is lost. Obviously, a player will have nothing to leave behind when the fifth card is revealed. It will be appreciated that the odds and house advantage discussed herein are changed in the event that a player elects to leave a bet on the table for a potential additional payout in a multi-card wager. Each player in roulette has their own “color” of chips of an established denomination, and this method is used in the disclosed game.

The suggested odds for the Pokerlette game were determined by the probability of the wagered events occurring, both in a random form and in some cases a “scattershot” form where the player might believe he/she can best the game by betting every possible outcome of a certain “inner board” wager. A discussion of these suggested odds follows. First, “inner board” wagering allows for a win on any of the revealed five cards, including a “single card” wager (e.g., FIG. 2, 201). This is a wager where one of the five revealed cards will be the desired card. The bet pays 9½ to 1 for a total return of 10% times the wager since the initial bet is also returned. A win can occur at any time in the hand that the desired card is revealed. The odds were derived by multiplying the 10½ by 5 win chances for a total of 52½. With a 54 card possibility, this leaves the house the remaining 1½ or 2.78%. Another way to examine this is to imagine a player placing a bet on all 54 cards. The player is guaranteed to win five times but will sacrifice the 2.78% reduction in payouts.

A “two card” wager is that one of two adjacent desired cards will be revealed in the hand (e.g., FIG. 2, 202). The bet pays 4 to 1 for a total return of 5 times the wager. Since two cards are simultaneously part of the wager, the best odds should produce one half the winnings of the “single card” wager or 4¼ to 1. There is a casino issue involved in that most will not deal in less than half dollar denominations. It is necessary to have a $10.00 per chip minimum to maintain this rule. This would make for a more expensive game. The other way to thoroughly analyze the odds for this wager is to divide the “two card” wager into “across” bets (e.g., Three of Spades and Three of Hearts), and “down” bets (e.g., Four of Spades and Five of Spades; FIG. 2, 202). There are forty possible across bets on the board when the two Jokers are included, as illustrated by the dashed-line circles (510) in FIG. 5. If a player made every available “across” bet, there would be 26 middle cards (Hearts and Clubs) which when revealed, would pay double if drawn (e.g., FIG. 5 arrows “2 winners”). This is due to the fact that they hold two “across” bets on either side of their square. These 26 cards pay 5 times the wager for two separate bets, or 10 times the wager. The remaining 28 outer cards (Spades, Diamonds and the Jokers) only hold one bet as represented by the arrows “1 winner”). If the player made all the across bets and was fortunate enough to have all Hearts and Clubs revealed, he would earn 10 times 5 cards or 50 units. Since only 40 units were wagered, the player would gain 10. On the other hand, if the revealed cards were all Spades, Diamonds and Jokers, the player would only earn 5 times 5 cards or 25 units. Since 40 were wagered, the player would lose 15. The average is ((26×10)+(28×5))/54 or 400/54, equal to an average payout per card revealed of 7.41 units. This multiplied by 5 cards equals 37.04 which is the average win on a 40 unit all “across” bet. The house advantage is ((40−37.04)/40)*100, or 7.4%.

There are 52 possible “down” bets on the board including the adjacent Aces and Jokers. Forty-eight of the middle cards and Jokers again would pay 10 units for the same reasons discussed above with “across” bets. The four Kings would only pay 5 units. Using the same math as the “across” example, the average is ((50×10)+(4×5))/54 or 520/54, equal to an average payout of 9.63 units per revealed card. This multiplied by 5 cards equals 48.15 which is the average win on a 52 unit “down” bet. The house advantage is ((52−48.15)/52)*100 or 7.41%.

This exercise was performed out of concern that a player could bet all the “across” “two card” bets and never lose. This would only be the case if the vast majority of revealed cards were Hearts and Clubs. As it turns out, 54 cards divided by 2 cards in the “two card” bet leaves 27. The payout over 5 cards is 4 to 1 times 5 or 25 units. ((27−25)/27)*100 equals a 7.41% house advantage.

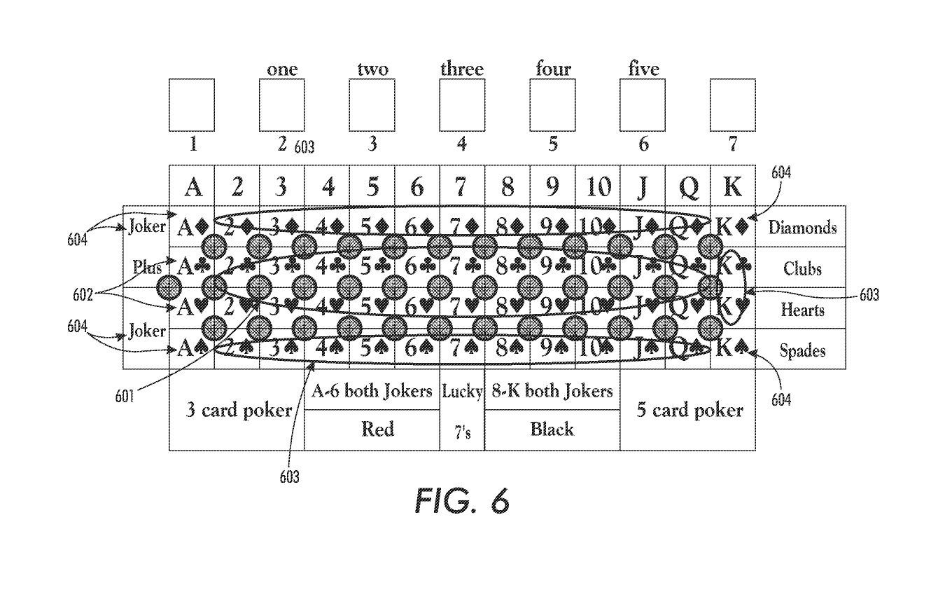

The “three card” wager pays 2½ to 1 odds. Fifty-four cards divided by 3 equals 18. 2½ to 1 returns 3½ units which, times 5 cards, equals a 17½ unit payout (this example is theoretical only, since there are only two places for this type of bet, see FIG. 2, 203). The equation ((18−17.5)/18*100) yields a 2.78% house advantage. The “four card” wager, at 1½ to 1 odds, also has two interesting ways of examining bets that are placed on the junction of four cards at their border intersection point (e.g., FIG. 2, 204). Suppose a player were to randomly place chips for five separate “four card” bets on the board with no overlap of card spaces. 54 cards divided by 4 equals 13½ possible bets on the entire board without overlap. If the player were fortunate enough to win all five of his bets when the five cards were revealed, his return would be 5 times 1½ to 1 odds or 5 times a 2½ betting unit return yielding 12½ betting units for the hand. Again, using the equation for house percent advantage, ((13.5−12.5)/13.5)*100, the resulting house advantage is 7.41%. Now imagine the player decides he/she might be able to beat the house by placing wagers on all possible “four card” locations on the board. There are 37 possibilities, 36 comprising the standard 52 card deck and the one junction of the two Jokers with the Aces of Hearts and Clubs. Of these 37 possibilities, if a revealed card showed any Heart or Club between 2 and Queen, the player would have all four corners covered and receive four payouts or a 10 unit return (e.g., FIG. 6, 601). There are 22 of these possibilities. The Aces of Hearts and Clubs are the two cards that have three corners covered as depicted in FIG. 6 at 602. They would return 3 payouts or 7½ units, if winners. If a revealed card was a Spade or Diamond between Two and Queen, or the Kings of Hearts or Clubs, there would be two corners covered for two payouts on these 24 cards (e.g., FIG. 6, 603). They would yield a 5 unit return. The Aces or Kings of Spades and Diamonds are the “corner” cards that, along with the two Jokers, only have a single corner covered as represented in FIG. 6 at 604. Their lone payout would yield a 2½ unit return. Using the same methodology as the “two card” bet, the possibilities are averaged out using the equation ((22*10)+(2*7.5)+(24*5)+(6*2.5))/54, which equals 370/54 or 6.85. Multiplying by the 5 revealed cards equals 34.25. As discussed previously, there are 37 wagers made to pay 34.25 units. The house advantage is ((37−34.25)/37)*100 or 7.41%. It would require odds of 1^{5/8} to 1 to get the advantage down to 2.78%. $20.00 chips would be needed to keep the $0.50 denomination rule. This would make for a very expensive game. Moreover it will be appreciated that there are alternative methodologies for handling multiple card wagers. For example, in one embodiment a multiple card wager only pays out once even if multiple cards are revealed that are “covered” by the wager. Alternatively, the game could be played to allow multiple payouts for each of the covered cards, although in such circumstances the player will have elected to risk again the initial bet at the given location and would lose it if a covered card did not subsequently appear.

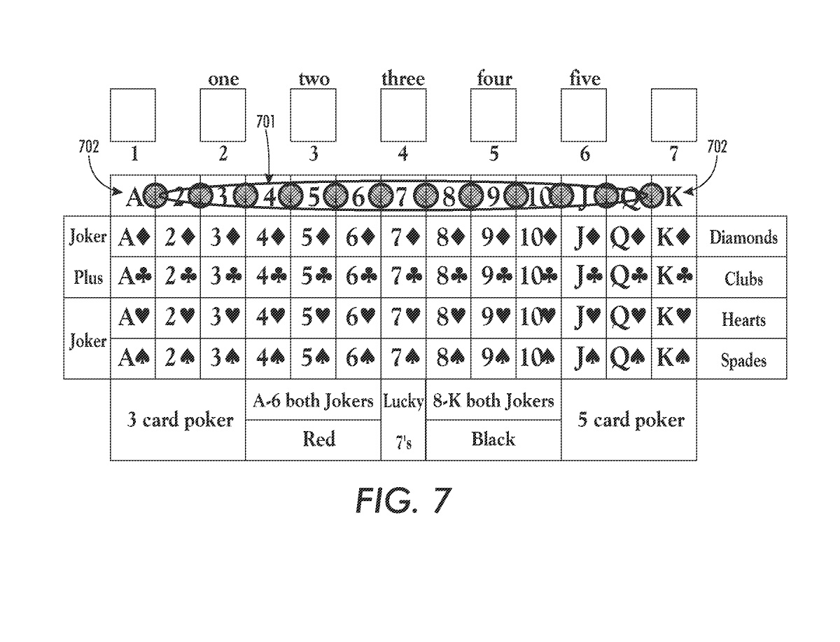

The “outer board” “first card” wagers are those that are settled after the revelation of the first card. For example, the “row” wager (FIG. 2, 205) allows the player to bet on the four cards of the same “face” out of the 54 card deck, and a winning wager pays 12 to 1 odds. The player could place chips on each row and cover the 52 standard cards, and only the two Jokers would lose. Here the calculation ((54−52)/54)*100 creates a house advantage of 3.70%. The “double row” wager (e.g., FIG. 2, 206) allows the player to bet on two “row” wagers simultaneously, covering eight cards by placing a chip on the border of two rows. It carries 5½ to 1 odds. There are 12 possible straddle positions on the row line covering the 52 standard cards as illustrated in FIG. 6. The Two to Queen cards would pay out twice for a return of 13 units (e.g., FIG. 7, 701). The Aces and Kings would pay out once for a 6½ unit return (e.g., FIG. 7, 702). Using the equation ((10*13)+(2*6.5))/12 to predict the average payout when a player covers all “double row” positions, an average of 143/12 or 11.92 results. This means the player on average can expect 11.92/12 or only 99.33% of his bet. With the “row” wager we found that 52 out of 54 cards gave a house advantage of 3.70%. The “double row” bet increases the advantage by 0.67% and the house ends up with a 4.37% edge. The “column” wager depicted, for example at FIG. 2, 207 allows the player to bet on the thirteen cards of the same “suit” out of the 54 card deck, and a winning wager pays 3 to 1 odds. The only cards out of play are the two Jokers. It takes 4 betting units to cover the 52 standard cards and a winner returns 4 units. The equation ((54−52)/54)*100, as seen in the “row” bet, yields a 3.70% house advantage. The “double column” wager (e.g., FIG. 2, 208) allows the player to make two “column” bets simultaneously by placing a chip straddling the two columns desired. It gives the player the opportunity to bet on half the board for the designated card and it pays even money at 1 to 1. On a random lone “double column” bet, the house advantage resides once again with the two Jokers and is 3.70%. If the player bet all three straddles, Spades and Diamonds would pay out a two unit return once, while Hearts and Clubs would pay twice. Finding the payout average with the equation ((2*2)+(2*4))/4 equals an average return of 12/4 or 3 units. Three straddles for 3 units leaves the Jokers once again for the house's 3.70% advantage.

Continuing to refer to FIG. 2, the “Red or Black” wagers (210, 212) allow for wagering on the color of the first revealed card. As in the other wagering covering half the standard deck, the house advantage is derived from the two Jokers for 3.70%. The “Ace to Six both Jokers” and the “Eight to King both Jokers” wagers (e.g., 209, 211) cover 24 standard cards and the two Jokers for a 26 card bet. As previously noted, the house advantage is one losing card in half the deck or two losing cards in the full deck for 3.70%. A player would find a different situation if he made both the “A to 6 both Jokers” and the “8 to K both Jokers” bets simultaneously. In this scenario there would be four losing cards in the deck, the four Sevens, and the house advantage rises to ((54−50)/54)*100 or 7.41%.

As will be appreciated, the Poker wagers have an entirely different methodology for odds determination since every possible combination of cards requires examination. The three-card poker hand wager is made when a player places one or more chips on the “three-card poker hand rectangle in FIG. 2 at 213. The player is wagering that the first three cards revealed will form a three card poker hand of at least a pair or better. Both Jokers are wild for this bet. There are 24,804 different combinations of three card hands, and computer software has been employed to analyze their breakdown. The following Table A describes the frequency of each hand and the odds which determine the casino's advantage.

TABLE A

| Rank | Frequency | Odds |
|---|---|---|
| Natural Royal Flush (no Jokers) | 4 | 100-1 |
| Royal Flush | 36 | 25-1 |
| Three of a Kind | 208 | 6-1 |
| Straight Flush | 260 | 5-1 |
| Straight | 1320 | 3-1 |
| Flush | 1520 | 2-1 |
| Pair | 5016 | 1-1 |

It was determined that the following odds would return 24,228 betting units. Again applying the equation for house advantage ((24,804−24,228)/24804)*100 provides a very fair 2.32% house edge. When a player places one or more chips on the “five card poker” rectangle in FIG. 2 at 214), he/she is wagering that after all five cards are revealed, a poker hand of at least one pair of Jacks or higher rank cards will result. Both Jokers are wild cards for hand formation. There are 3,162,510 possible combinations (data provided by Bill Butler at www.durangobill.com). The following table (Table B) describes the frequency and odds of each type of hand.

TABLE B

| Rank | Frequency | Odds |
|---|---|---|
| Five of a Kind | 78 | 600-1 |
| Royal Flush | 84 | 500-1 |
| Straight Flush | 540 | 100-1 |
| Four of a Kind | 9360 | 10-1 |
| Full House | 9360 | 10-1 |
| Flush | 11338 | 7-1 |
| Straight | 34704 | 5-1 |
| Two Pairs | 123552 | 3-1 |
| Three of a Kind | 232968 | 2-1 |
| Jacks or Better | 624696 | 1-1 |

It was determined the following odds would return 3,083,454 betting units. Applying the equation for house advantage ((3,162,510−3,091,254)/3,162,510)*100 yields a 2.253% edge for the casino. The “Lucky 7's™” wager provides a feature for making side wagers independent of the main game. In “Caribbean Stud” poker, a $1.00 side bet allows the player to vie for a share or all of a “Progressive” pot, independent of how he fares against the dealer.

There are different methods for placing this bet on a “Caribbean Stud” table. Some tables have a slot in front of the player where a $1.00 denomination chip is placed. The dealer pushes a button on a console in front of him and the computer registers which players have made the bet. Such a method may be employed in one or more of the embodiments disclosed herein. Another method allows the player to pre-pay the dealer for a requested number of tries. This number is registered by a counter in front of the player, who pushes a button on the counter for each hand that he wishes to participate in the side bet. The dealer has the participants registered on his console and he locks them in during the betting phase of the hand.

A third method has a lighted disk with an imbedded sensor in front of each player. Players who wish to make the wager place a $1.00 chip on the lit disk. The dealer registers the bets on their console and removes the chips. Those who made the bet have their disks stay lit while the others go unlit. For Pokerlette™ another alternative betting method would be for a player to place $1.00 chips on the “Lucky 7's™” rectangle, signifying his/her desire to participate in the side bet. A variation is to place a higher denomination chip in the “Lucky 7's™ rectangle. The dealer then places an equal number of $1.00 chips under this chip and removes one after each losing hand. The last chip removed has the high denomination chip go with it as a loss. Moreover, where multiple players wish to employ this type of wager, the casino might instruct the dealer to move these wagers (chips representing the wagers) to a pre-designated area such as the empty area between the playing board and the card revelation spaces so that the dealer could keep watch on these bets and prevent the stack of chips from being tampered with. Alternatively, the layout of the game board could be modified to reduce the likelihood of cheating. It is important to note, however, that the use of playing cards permits a distinctive halt to betting prior to any cards being revealed versus roulette where betting is supposed to stop when the ball is dropped, but focus is then on the wheel and some wagers may be snuck in after the fact.

The “Lucky 7's™” bet is a slot machine type of bet, where the playing cards act as the “reels” of the slot machine. There may be other methodologies to register participation in the Lucky 7's side bet, which would be understood to be within the scope of this disclosure, and would in no way alter the game or create a new one. There is no poker hand evaluated with this bet, other than the number of Sevens and Jokers that appear amongst the five revealed cards. A special feature of this aspect of the game is the option of a “progressive” pot found in many electronic and mechanical slot devices. If four natural Sevens appear with one of the two Jokers, the betting players divide the pot, with a minimum of $100,000 for each player. If three Sevens occur with both Jokers, the betting players split 10% of the pot with a minimum of $10,000 for each. The odds are designed for 5% of losing side wagers to be added to the “progressive” pot. In this embodiment, a minimum combination of three Sevens or Jokers is needed for a win. As in the “five card poker” hand, there are 3,162,510 combinations that can appear. The odds, as reflected in the following Table C, are based on a separate computer program, which determined the probabilities.

TABLE C

| Rank | Frequency | Odds |
|---|---|---|
| Natural Five of a Kind | 2 | Progressive |
| (Four Natural Sevens) | | |
| Five of a Kind | 4 | 10% Progressive |
| Four Natural Sevens | 48 | 2000-1 |
| Four of a Kind | 672 | 500-1 |
| Three of a Kind | 22560 | 100-1 |

For the Lucky 7's wager, the odds would return a possible 2,928,000 betting units or ((3,162,510−2,928,000)/3,162,510)*100=7.415%, which is the house advantage. Since, as described above, 5% of the take would be rolled back into the progressive pot, the actual house advantage is 2.415%. As will be appreciated, it is possible to alter the payouts for the Lucky 7's and other wagers, and that the house, or a gaming commission, may determine the payout as necessary. In other words, the odds and payouts used in this game are suggested odds and payouts, and can be adjusted to alter the outcomes discussed above.

In an alternative embodiment, it is also possible to provide a payout for a Lucky Sevens bet for just a pair of Sevens or Jokers, and thereby provide combinations that may make the bet more attractive for players. For this alternate Lucky 7's the frequency for a pair is approximately 259,440 possible combinations. For example, the following scenario (Table D) has an 8.89% house advantage before the progressive skim.

TABLE D

| Rank | Payout |
|---|---|
| Natural Five of a Kind - Progressive | (Min. $100,000) |
| Five of a Kind - 10% Progressive | (Min. $10,000 |
| Natural Four of a Kind | $1,000 |
| Four of a Kind | $250 |
| Three of a Kind | $50 |
| Pair | $5 |

There are other variations of the game. Several known variations, although removed to simplify the game description above, are presented in the following summary: (1) in one embodiment, the “inner card” payoffs are at descending odds dependent on the timing of the revelation of the desired card. If the first card was a winner for the player, that player would receive the highest payoff, whereas a wager paying off from the last card revealed would receive the lowest payoff; (2) as previously discussed, the odds can be altered to enhance either the player or house advantage, in another embodiment, a “two card” wager at 4¼ to 1 and/or a “four card” wager at 15/8 to 1 are fairer to the player, but they create an untenable situation for casinos refusing to work with less than half dollar denominations; (3) The game may also include an “Ace to Four and Joker Plus™” bet, a “5-6-8-9-Joker Plus™” bet, and a “Ten to King and Joker Plus™” bet; (4) The game may also be played using three Jokers. The third or “Bug” (Pai Gow Poker) Joker would not count in any hands other than to create better casino odds for first card bets or “inner table” bets. One extra card would be dealt as the “replacement” card to replace the third Joker for the poker bets. The board would have a separate space for the “replacement” card and an attached third Joker betting space above the other two Jokers (see FIG. 5). Notably, this last feature may make the game odds too unattractive to a sophisticated gambler.

With regard to the half-dollar denomination noted above, when $5.00 chips are used in the game, there are many instances where one-half chip payouts result in $0.50 (half-dollar) denominations being required. This could be handled in different ways. In one embodiment, half dollar coins can be used to make the payments. Another alternative would be to use half-dollar chips or ½ value chips. Yet another alternative would be to keep track of half chip wins mechanically or electronically per player, and provide said player with a whole chip after two ½ chip wins. The casino may choose to eliminate ½ chip payouts, but this would tilt the odds much more in their favor and make the game unattractive to the sophisticated gambler. This is not to construe that any methodology to handle this $0.50 situation would significantly alter the invention in any way.

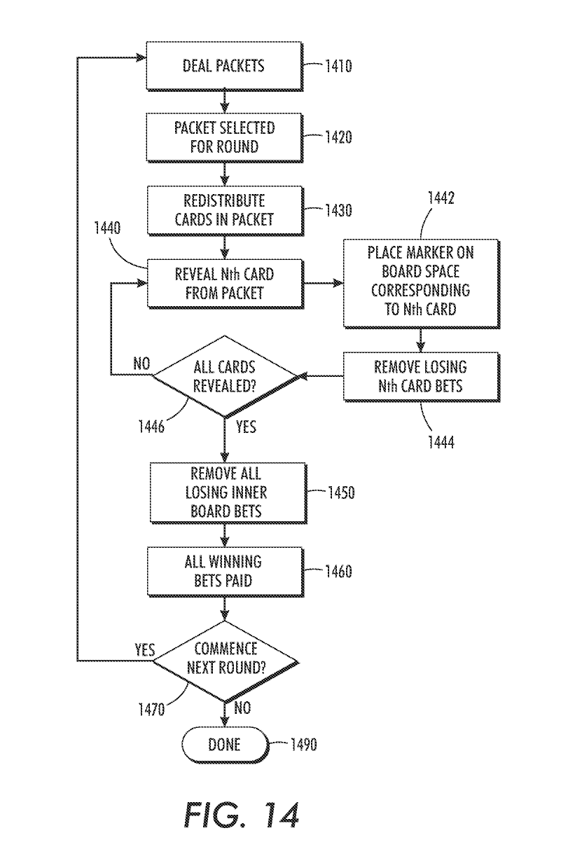

In yet another alternative embodiment, the manner of playing an exemplary game is characterized from the perspective of the dealer, where the specific actions carried out by the dealer are represented in the flowchart of FIG. 14, and described in conjunction with the game-board layout of FIG. 15. As noted previously, the game may be played on a number of surfaces, and the layout 1500 of FIG. 15 is intended to be employed with a conventional black-jack or Big-Six style playing table or surface (e.g., a table of approximately 70-80 inches in length by approximately 40-50 inches in width and having at least one curved edge for players to sit or stand along), although a suitable rectangular-shaped table will suffice as well. Moreover, a card-dealing system, represented by 1510, may be placed on or adjacent the surface. Initially, the game begins when the player places a bet or wager on the “inner board” and/or “outer board” as follows:
(1) Inner board bets may be placed on individual spaces, borders, intersections or rows;
(2) Inner board bets have five chances to win, and once the cards are revealed, inner board losing bets may be removed, leaving winning bets until the end for payment;
(3) Outer board bets for first card only (or other designated card) may be placed on one or multiple columns representing card suits, on one or more rows representing card faces, card color (Red or Black), and/or “A to 6 both Jokers, “8 to K both Jokers.
(4) Poker-type bets are either three or five card wagers that the revealed cards will form a pair or better for the three-card bet, or a pair of Jacks or better for the five card bet (where Jokers are wild cards for the poker bets.
(5) Another possible bet is the Lucky 7's™ bet, a side bet that creates a “slot-machine” where each revealed card is one on a “reel”, so that if two or more Sevens and Jokers appear, the bet is paid out, with a progressive payout when four natural Sevens and a Joker appear.

Then, as represented by 1410, the dealer puts out or deals seven “packets” of five cards each on designated card presentation region or “dealer area” 110. Next, one of the seven packets of cards in the dealer areas is selected as represented at 1420. In one version of the game, a player may select the packet. Alternatively, the packet may be selected by any one of a number of randomized packet selection means described above to avoid any possible player advantage (e.g., a die if six packets are used). And, it is further contemplated that the randominzed selection mechanism may itself, be the subject of wagers. To designate the selected packet, a packet marker is placed on the selected packet, and then all other card packets in the dealer or layout area are placed in discard rack.

Subsequently, as indicated by 1430, the dealer distributes the cards from the selected packet on the playing surface 1500 on the middle five spaces marked “1^{st}” through “5^{th}” in region 110. All cards continue to be maintained in a face-down (non-visible) orientation. Once the cards in the selected packet have been distributed, the dealer announces, “The betting is closed,” and players are asked to remove their hands from the table.

Next, as represented by a looping set of operations (1440-1446) in FIG. 14, the dealer successively reveals cards. More specifically, as represented by 1140, the dealer reveals the first card (N). The dealer then places a marker on the corresponding representation of the revealed card on the inner board space in region 124 (FIG. 15). Next, all losing first (Nth) card bets are removed (1444). If more cards remain, the process at 1440-1444 is repeated for each of the remaining N cards, until no more cards are left. More specifically, the operation loops so that the dealer reveals the second card, marks it and then reveals the third card and marks it. Then with the third card revealed, all losing three card poker bets, which may also be designated as “first three cards” bets are removed. Subsequently, the iterative process continues so that the dealer reveals the fourth card and marks it, then reveals the fifth card and marks it. And, having revealed all five cards in the packet, all losing five card poker bets, which may also be designated as “five cards bets” are removed. Although the method described refers to three card and five card bets, it will be appreciated that other multiple card wagers may be made, and that cards relating to those bets could similarly be removed at the appropriate times. Next, as reflected by 1450, with all cards revealed, all losing bets within the inner board region 124 are removed from the dealer's right to left, and most likely one chip color at a time to make it more efficient to return chips to the house's rack. Then, as reflected in 1460, the winning bets are paid, preferably where all winning outer board bets are paid (where outer board indicates the adjoining regions around the inner board 124), followed by all winning inner board bets, which are paid from dealer's fight to left, again paying out for one player (chip color) at a time. Those players having won with a single-card chip in the inner board are offered the option of leaving or removing winning the single-card chips under dealer markers, before the next round commences as represented by 1470.

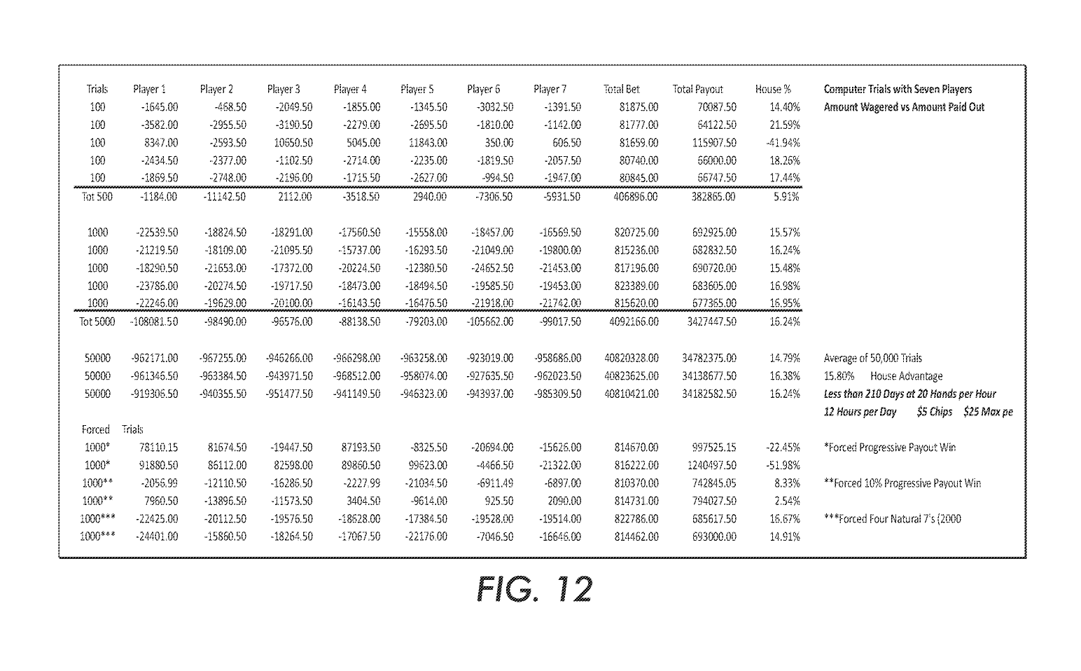

Turning briefly to FIG. 12, depicted therein is a spreadsheet representing the result of an exemplary simulation for one embodiment of the Pokerlette game disclosed above. In the figure, there is an assumption that the game is played with seven players, with wagers ranging from $0 to $25. The trials represented were conducted using random card generation with random packet distribution and packet selection, and are intended to illustrate exemplary outcomes over various trials. As will be noted for the initial trials assuming 100 hands, only one of five trials resulted in a loss to the house, and in the trials for 1,000 and 50,000 hands, no loses were reported for the house. At the bottom of the spreadsheet, under “Forced Trials”, the noted 1,000 hand trials included forced payouts for the low-odds wins with the Lucky 7's wagers. The only two trials that resulted in a loss for the house occurred when a win was forced for the “progressive” payout. As a result of the trials conducted, it is believed that one or more embodiments of the game as disclosed herein would result in a viable gaming opportunity.

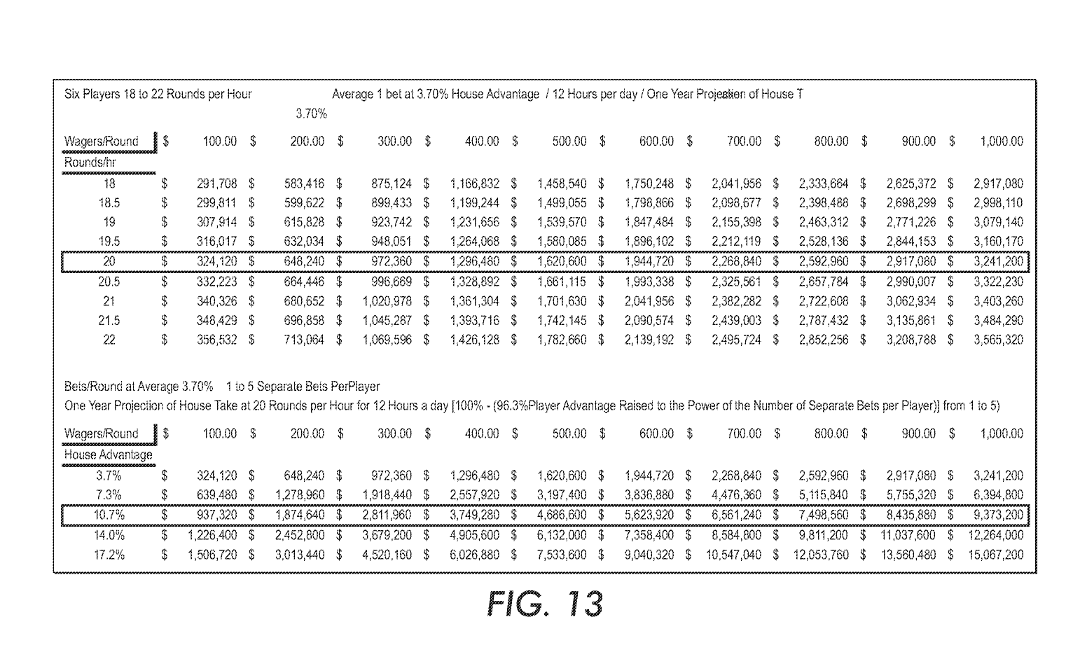

FIG. 13 is a spreadsheet illustrating two examples the potential revenue a casino may obtain based upon the varying factors of cumulative wagering amount ($) per hand, and number of hands played per hour (assuming six players per hand). For example, in the top example, assuming 20 hands/hour, and an average house take of 3.7% per hand, an average cumulative total wagering of $500/hand (and the other assumptions set forth at the top of the table), the house could expect an annual revenue of $1,620,600. In the bottom table of FIG. 13, there are a number of revenue scenarios based upon a combination of the house advantage (ranging from 3.7% to 17.2%) and wagering/hand of $100 to $1,000. The resulting revenues are calculated for one year using the other assumptions set forth at the top of the table.

As noted above, it may be most efficient for a dealer to clear losing or winning wagers by color to facilitate returning the chips to a stack or paying out winning wagers. Although not specifically illustrated in FIG. 15, the table surface or an adjoining surface may also have space to support a chip rack or tray. It is recommended that with a table that can accommodate up to approximately six or seven players, a 12-tube rack may be employed, with six or seven tubes dedicated to player color chips and the remaining five tubes used for larger value chips. Although the disclosed embodiments suggest up to six or seven players, it will be appreciated that the game layout and table orientation, and the on-line or video-gaming embodiments described above, facilitate more or fewer players, and the disclosed embodiments are not intended to indicate a particular number of players or limit on the number of players.

It will be further appreciated that while several examples or techniques for placing wagers have been described, there are various alternatives that may be employed to reflect or record the wagers of players or users of systems that implement the disclosed game. For example, in a computer-based implementation, the user's selection (e.g., mouse-click) of a wagering location may result in an auxiliary menu (e.g., drop-down menu) with various wagering amounts for selection. And, once made, the wagers may be illustrated in various ways using alternative background or foreground colors, shading, etc. It may also be possible to simulate the physical game, by providing a movable “chip” that can be placed or dragged/dropped on a wagering location. The details of such wagering techniques are not disclosed herein as they are believed to be known relative to other on-line and portable or hand-held casino gaming technologies.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A method of playing a game, comprising:
(a) providing a deck of playing cards that includes two Joker cards;
(b) providing a wagering area in which wagers may be placed by participants in a roulette-type fashion, wherein the area includes
(1) an inner board comprising, a plurality of spaces representing single card wagers and multiple card wagers that any revealed cards will be the single card or one of a group of multiple cards;
(2) an outer board comprising a plurality of spaces to represent a wager for at least one of a predetermined group of wagers;
(c) providing a card presentation region, said presentation region including a plurality of layout spaces located separate from the wagering area; and
(d) the game being played by the following steps,
(1) at least one player commences wagering by placing a marker of said wager in the wagering area,
(2) dispensing at least one packet of five cards,
(3) placing each packet on its own layout space,
(4) making a packet selection, if more than one packet is dispensed, for use in the game, and discarding all non-selected packets to leave a selected packet,
(5) laying out all five cards of the selected packet face-down in order on the layout spaces, and announcing the end of wagering,
(6) successively revealing the first through fifth cards, and
(7) paying all winning wagers.

2. The method according to claim 1, where subsequent hands are completed by repeating (d).

3. The method according to claim 1, wherein at least a portion of at least one of the wagers is retained for future payout in a progressive pot.

4. The method according to claim 1, wherein a multiple card wager is allowed to remain as a wager for a subsequent card within the same hand.

5. The method according to claim 1, wherein the predetermined group of wagers includes at least one wager selected from the group consisting of:
the suit of a designated card regardless of face;
the face of the designated card regardless of suit;
the designated card will be a face card from one of six cards;
the designated card will be of a particular color;
the first N cards revealed will form a winning poker hand; and
at least two cards forming a combination of Sevens and Jokers will appear among the five cards revealed.

6. The method according to claim 5, wherein paying those wagers for which markers remain in the wagering area, includes paying first card wagers.

7. The method according to claim 5, wherein paying those wagers for which markers remain in the wagering area, includes paying poker hand wagers.

8. The method according to claim 1, wherein paying those wagers for which markers remain in the wagering area, includes paying inner board wagers.

9. The method according to claim 1, wherein paying those wagers for which markers remain in the wagering area, includes paying outer board wagers.

10. A casino game board comprising a wagering area in which wagers may be placed by at least one participant in a roulette-type fashion, wherein said wagering area includes
(1) an inner board comprising, a rectangular layout including 52 playing card spaces in a 13×4 rectangular arrangement each representing one of the 52 cards, said spaces being arranged in columns by suit and in rows by card, from Ace to King, and two Joker rectangles each representing one of the two Jokers, where the playing card and Joker rectangles allow for wagering on single cards or groups of two, three or four cards that any of five revealed cards will be the single card or part of a group;
(2) a plurality of rectangular areas for wagering on one or two suits of the designated card regardless of face;
(3) a plurality of areas to allow for wagering on one or two sets of faces of the designated card regardless of suit;
(4) a plurality of areas for wagering that the designated card will be a face card from Ace to Six or either Joker;
(5) an area for wagering that the designated card will be red in color;
(6) an area for wagering that the designated card will be a face card from Eight to King or either Joker;
(7) an area for wagering that the designated card will be black in color;
(8) an area for wagering that the first three cards revealed will form a winning three-card poker hand;
(9) an area for wagering that all five cards revealed will form a winning five card poker hand; and
(10) an area for wagering that a minimum of two Sevens or Jokers, or any combination thereof, will appear among the five cards revealed.

11. The casino game board according to claim 10, further comprising a card presentation region, said presentation region including a plurality of layout spaces located in a region away from said wagering area.

12. The casino game board according to claim 10, wherein the board is present on a generally planar horizontal surface.

13. The casino game board according to claim 10, wherein the board is presented on an electronic display as an electronic game with single player or multiplayer settings.

14. The casino game board according to claim 13, wherein the board is presented as part of a portable electronic game for a mobile device.

15. The casino game board according to claim 13, wherein the board is presented as part of a game played over the internet with remotely-located players.

16. A method of playing a casino game, comprising:
(a) providing a deck of at least 54 playing cards that includes two Joker cards;
(b) providing a space in which wagers may be placed by participants in a roulette-type fashion, wherein the area includes
(1) an inner board comprising, a rectangular layout including 52 playing card spaces in a 13×4 rectangular arrangement representing the 52 cards, said spaces being arranged in columns by suit and in rows by card, from Ace to King, and two Joker rectangles each representing one of the two Jokers, where the playing card and Joker rectangles allow for wagering on single cards or groups of two, three or four cards that any of five revealed cards will be the single card or part of a group;
(2) a plurality of rectangular spaces for wagering on one or two suits of the designated card regardless of face;
(3) a plurality of spaces to allow for wagering on one or two sets of faces of the designated card regardless of suit;
(4) a plurality of spaces for wagering that the designated card (e.g., first card revealed) will be a face card from Ace to Six or either Joker;
(5) a space for wagering that the designated card will be red in color;
(6) a space for wagering that the designated card will be a face card from Eight to King or either Joker;
(7) a space for wagering that the designated card will be black in color;
(8) a space for wagering that the first three cards revealed will form a winning three-card poker hand;
(9) a space for wagering that all five cards revealed will form a winning Five Card Poker hand; and
(10) a space for wagering that a minimum of two Seven face cards or Jokers, or any combination thereof, will appear among the five cards revealed;
(c) providing a card presentation region, said presentation region including a plurality of layout spaces located separate from the wagering area; and
(d) the game being played by the following steps,
(1) commencing wagering;
(2) dispensing seven packets of five cards each, with the remaining cards being placed in a discard rack;
(3) placing the packets on seven layout spaces located separate from the wagering area;
(4) a selected player announcing a choice for selection of one of the seven packets, placing a dealer marker on the selected packet for use in the game as the game packet, and all remaining packets being placed in the discard rack;
(5) laying out the five cards face down and ending wagering;
(6) revealing the first card.
(7) all first card wagers are settled and any “inner board” winners are paid;
(8) revealing the second card.
(9) any “inner board” winners are paid;
(10) revealing the third card
(11) all three-card poker hand wagers are settled and any “Inner Board” winners are paid;
(12) revealing the fourth card
(13) any “inner board” winners are paid;
(14) revealing the fifth and final card of the game.
(15) all “five card poker”, “Lucky 7's™”, and any “inner board” winners are paid; and
(16) the hand ends.

17. The method according to claim 16, where subsequent hands are completed by repeating (d).

18. The method according to claim 16, wherein at least a portion of at least one of the wagers is retained for future payout in a progressive pot.

19. The method according to claim 16, wherein a multi-card wager is allowed to remain as a wager for a subsequent card within the same hand.
